(19) United States
(12) Patent Application Publication
(10) Pub. No.: US 2025/0215367 A1
(43) Pub. Date: Jul. 3, 2025

(54) USE OF CHITOSAN-PHYTATE POLYMER IN OENOLOGY

(71) Applicant: ESSECO S.R.L., Trecate (Novara) (IT)

(72) Inventors: Gianni TRIOLI, Piacenza (IT); Marco Cesare MANFREDINI, Milano (IT)

(21) Appl. No.: 18/843,689

(22) PCT Filed: Mar. 2, 2023
(86) PCT No.: PCT/IB2023/051939

§ 371 Date: Sep. 3, 2024

(30) Foreign Application Priority Data
Mar. 2, 2022 (IT) 102022000003848

(51) Int. Cl. C12H 1/056; C08B 37/08

(52) U.S. Cl. CPC C12H 1/0424; C08B 37/003

(57) ABSTRACT

The invention relates to the use of a polymer obtained from the cross-linking reaction between chitosan or a derivative thereof, for example carboxymethyl chitosan, and phytic acid or a salt thereof, to prevent and/or to mitigate the phenomena of oxidation of a fermented beverage, preferably an alcoholic fermented beverage.

The alcoholic fermented beverage can be red, white or rosé wine.

The polymer of the invention acts by removing the iron ion, which is the cause of oxidative phenomena.

### FIELD OF THE INVENTION

The present invention relates to a polymer based on chitosan and/or a derivative thereof, phytic acid or a salt thereof and optionally polyaspartate, and the use thereof to treat fermented beverages, in particular wine, in order to prevent phenomena of oxidation and/or precipitation of calcium tartrate crystals.

### BACKGROUND OF THE INVENTION

Wine is derived by pressing grapes to extract the must, which is fermented by yeast that transforms the natural grape sugars into alcohol. Fermentation can take place in contact with the grape skins, from which larger amounts of polyphenols (responsible for the wine's colour), aromas, metals and other components are thus extracted.

The wine thus obtained is kept for a period varying from a few weeks to several years, according to type, until it is ready for packaging and market distribution. Before being consumed, wine can be stored for many more months or years at the point of sale or in the buyer's cellar.

During the period of storage in a tank, barrel or bottle, the wine naturally encounters phenomena of a chemical and microbial character.

The chemical process of greatest practical relevance is oxidation, which leads to significant changes in colour, aroma and taste and, beyond a certain limit, to the complete devaluation of the product. Wine oxidation is a complex process, which involves numerous chemical species deriving from grapes and requires—in addition to oxygen—the presence of a metal that acts as a catalyst: iron. In fact, it is iron which, on becoming oxidated, leads to the formation of radicals that are much more reactive than oxygen itself, and which in turn generate quinones from grape polyphenols. Iron thus triggers a redox cascade reaction which modifies the colour and produces aldehydes: in the initial phase, oxidation leads to the loss of the primary aromas characteristic of the grape variety or region, and in the more advanced phases causes the colour to turn brown and gives rise to smells of honey, cut apple and potato peel, which completely denature the wine until making it undrinkable. This process of deterioration is more evident in white and rosé wines than in reds.

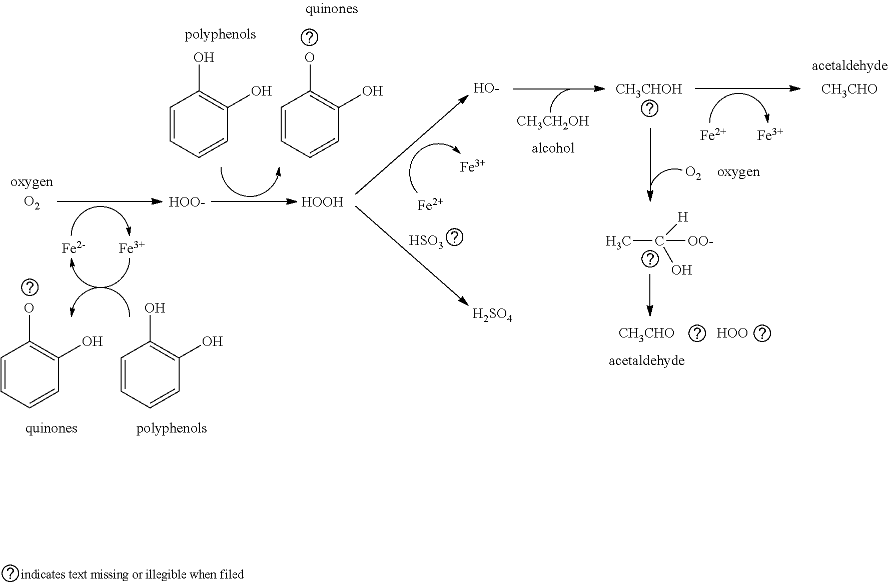

### Diagram of the Oxidation Reactions Caused by Iron

At present, the approaches followed to prevent oxidation are of a preventive, subtractive or additive type, often together in combination.

One strategy is to reduce the presence, in wine, of polyphenols, which trigger a cascade oxidation reaction: this is done preventively by avoiding maceration with the skins and reducing the pressing of marc; the removal of polyphenols, by contrast, is carried out with carbon, casein or other proteins allowed by regulations.

As for the reduction of iron, the authorised practice that gives significant results is ferrocyanide treatment, by now abandoned due to the toxicological risks tied to the use of potassium ferrocyanide. A partial deferrization effect can also be obtained with a chitosan-based treatment of microbial origin, or calcium phytate salts or polyvinyl imidazole-polyvinylpyrrolidone PVI-PVP resin (oenological practices admitted under Reg. EU 934/2019)

The additive approach envisages the addition of reducing substances that, upon reacting with radicals, block the chain of reactions: for this purpose, use is essentially made of sulphur dioxide, sometimes in combination with ascorbic acid.

All the practices indicated above have limits of effectiveness or side effects, at times even major ones, which make a solution for the oxidation and microbial contamination of wine still necessary.

Less extraction of oxidisable polyphenols from grapes goes hand in hand with less extraction of aromas and their precursors, polysaccharides, metals, amino acids, etc., likewise contained above all in grape skins and essential in determining aromatic intensity, volume, sapidity and, ultimately, a wine's quality and identity. Therefore, a wine obtained with little or no contact with the skins will be less oxidisable, but also blander and with a lower market value. Similarly, treatments with casein, protein and carbon are not selective and, together with the polyphenols, they remove compounds that contribute positively to determining the quality of the wine. The current deferrization treatments also have strong limits of application and have thus been fundamentally abandoned in practice. The use of potassium ferrocyanide is still authorised, despite it being a toxic substance, but with specific legislative restrictions aimed at ensuring no residues are left in the wine; it requires the keeping of a specific register and the intervention of a responsible oenologist. Due to the growing attention to the health of consumers, practically no producers now use ferrocyanide treatment to avoid from the outset risks of a toxicological alarm on its products.

The adjuvant calcium phytate, despite being allowed under current legislation, has also fallen totally into disuse because the qualitative damage caused by the treatment has shown to be greater than the benefit obtained with deferrization. In fact, calcium phytate is capable of removing iron only in ferric and not ferrous form, at high treatment temperatures: in practice, it is thus necessary to heat and oxygenate the wine in order to be able to eliminate a significant portion of iron, thereby causing, however, a considerable qualitative deterioration of the wine.

The synthetic polymer PVI-PVP has recently been authorised by legislators among oenological practices, but it poses various problems related to application. First of all, it is a very fine powder, difficult to handle, which can cause irritation in the respiratory tract of operators; it cannot be used in the early phases of vinification, must be removed from the wine after a few hours and, finally, it has a very substantial cost for winegrowing enterprises. It should be considered that treatments with ferrocyanide, phytate and PVI-PVP are not allowed under the regulations for organic and biodynamic wines, which represent an important and growing share of wine production. Treatment with chitosan is a practice that may be implemented in modern vinification to reduce iron in a solution; however, even at very high doses (up to 200 g/hl), the iron present in the wine can be reduced by 50% at most. In consideration of the high cost of the product, chitosan alone thus offers an only partial solution to the problem of the catalysing effect of iron in the oxidation of the wine.

In addition to the problem of oxidation caused by iron, fermented beverages, and wine in particular, pose the problem of calcium content.

Calcium is a metal naturally present in wine at concentrations that may exceed 100 mg/l, an increasingly frequent situation as a consequence of climate change. If present above the solubility equilibrium of wine, calcium tartrate forms crystals which bring about a deposit in the bottle that consumers find unpleasant. Unlike potassium tartrate, calcium tartrate has a very slow, non-temperature-dependent crystal formation process; therefore, many classic stabilisation practices applied to wine (cold stabilisation, addition of polyaspartate at the authorised doses, etc.) are not able to prevent the phenomenon. Removing a part of the calcium present from wine, the tartaric acid content being equal, lowers the concentration of calcium tartrate below the solubility thereof and thus prevents its crystallisation.

The present invention provides an effective solution for overcoming both the problem of the oxidation caused by iron and the problem of crystal formation caused by the excessive presence of calcium in fermented beverages, in particular in alcoholic fermented beverages and preferably in wine.

### SUMMARY OF THE INVENTION

The present invention relates to a polymer based on chitosan and phytic acid, or salts thereof, or a polymer based on chitosan, phytic acid or salts thereof and polyaspartate. The invention also relates to the use of a polymer based on chitosan and phytic acid, or salts thereof, and/or a polymer based on chitosan, phytic acid or salts thereof and polyaspartate to remove the iron and/or calcium ion from fermented beverages, preferably alcoholic fermented beverages, in particular wine, preferably white, red or rosé wine. The polymer based on chitosan and phytic acid or salts thereof is obtained by cross-linking between chitosan and phytic acid or salts thereof.

The polymer based on chitosan, phytic acid or salts thereof and polyaspartate is obtained by cross-linking between phytic acid or salts thereof and chitosan, during which polyaspartate is added.

The polymer based on chitosan and phytic acid or salts thereof has demonstrated to be particularly effective in selectively removing the iron ion from a fermented beverage, preferably an alcoholic fermented beverage, more preferably wine. Therefore, this polymer is used to prevent and mitigate the oxidation phenomena caused by the iron ion.

The polymer based on chitosan, phytic acid or salts thereof, and polyaspartate, has demonstrated to be particularly effective in simultaneously removing the iron ion and calcium ion from a fermented beverage, preferably an alcoholic fermented beverage, more preferably from wine, while showing good levels of selectivity for such ions. Therefore, said polymer is used to prevent and mitigate the oxidation phenomena caused by the iron ion and/or the formation of calcium tartrate crystals that deposit on the bottom of the container containing the beverage.

The invention also relates to a method for removing the iron and/or calcium ion from fermented beverages, preferably alcoholic ones, in particular wine, which comprises a step in which the beverage is placed in contact with a polymer based on chitosan and phytic acid or salts thereof and/or a polymer based on chitosan, phytic acid or salts thereof, and polyaspartate. The polymer is maintained in contact with the beverage for a time comprised between 1 day and 10 days, preferably between 2 days and 7 days. The beverage is subsequently filtered, centrifuged or decanted to eliminate the polymer suspension.

### BRIEF DESCRIPTION OF THE FIGURES

FIG. 1 shows the results of the removal of the iron ion from a white wine using different polymers for comparison: chitosan-sodium phytate polymer (CS-NP); chitosan-phytic acid polymer (CS-AP); chitosan-potassium phytate polymer of (CS-KP); chitosan-polyaspartate polymer (CS-KPA); chitosan-phytate-polyaspartate polymer (CS-AP-KPA).

FIG. 2 shows the effect of the time of contact between a chitosan-phytate polymer and a white wine.

FIG. 3A shows the selectivity of the CS-AP polymer of the invention for iron versus other ions in white wine.

FIG. 3B shows a reduction in oxidation phenomena due to the removal of iron in white wine.

FIG. 3C shows the effects of treatment of the CS-AP polymer on the tonality of a white wine.

FIG. 4A shows the results of the removal of iron in red wine by the CS-AP polymer.

FIG. 4B shows the effect on oxidation of the removal of iron in red wine.

FIG. 4C shows the effect of the CS-AP polymer on the phenolic profile of a red wine.

FIG. 4D shows the effect on colour of a red wine treated with the CS-AP polymer.

### DETAILED DESCRIPTION OF THE INVENTION

The term “chitosan” means chitosan or a derivative thereof, such as, for example, carboxymethyl chitosan.

The present invention relates to a polymer obtained from the cross-linking reaction between chitosan of formula (I) and/or a derivative thereof, for example carboxymethyl chitosan:

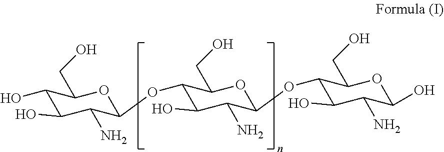

and phytic acid of formula (II):

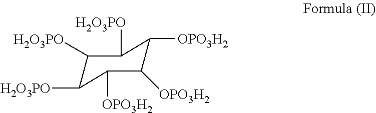

or a salt thereof, preferably a salt of an alkali or alkaline earth metal, for example sodium, potassium, calcium or magnesium phytate or combinations thereof,
and optionally polyaspartate, more preferably polyaspartate of an alkali or alkaline earth metal, for example potassium polyaspartate having the formula (III):

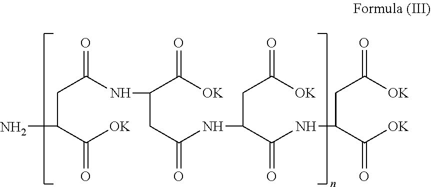

The phosphate groups of phytic acid or a salt thereof bind, by ionic bonding, to the ammonium groups of chitosan, thus forming a stable cross-linked structure that gels. The reaction is made to take place in such a way as to ensure that a part of the phosphate groups of phytic acid or a salt thereof does not bind to chitosan, thus remaining free to chelate iron and/or calcium, for which it has a strong affinity.

If polyaspartate is present, it reacts with chitosan, since, like phytic acid, it has a strong negative surface charge, thus giving rise to the formation of a cross-linked polymer based on chitosan, phytic acid or salts thereof and aspartate.

In particular, two or three aqueous solutions are prepared depending on whether one wishes to obtain a polymer based on chitosan and phytic acid, or a polymer based on chitosan, phytic acid and polyaspartate: a solution containing chitosan, preferably an acidic solution, a solution containing phytic acid or a salt thereof and a solution containing polyaspartate.

The aqueous solution of phytic acid or salts thereof is obtained by solubilising, in demineralised water, the phytic acid or the sodium, potassium, calcium or magnesium salts thereof, also in a mixture between the latter.

The aqueous solution in which the chitosan is dissolved is acidified with an organic acid selected from: acetic, lactic, tartaric, malic, citric and ascorbic acid and combinations thereof. These acids are compatible with use in food and are normally present, for example, in wine.

In the case of preparation of the polymer based on chitosan and phytic acid or salts thereof, the solution of chitosan is added, preferably slowly, to the solution of phytic acid or salts thereof, under stirring, preferably in the presence of a pore-forming agent, for example KCl or NaCl. The weight/weight proportion between the chitosan and phytate used in the polymer's synthesis ranges from 0.1 to 20, preferably from 0.1 to 10.

The reaction is allowed to continue at room temperature for a time of between 1 hour and 72 hours, preferably between 4 and 24 hours, with the formation of a white precipitate, the polymer, which is subsequently recovered.

The phosphate groups of phytic acid bind by ionic bonding to the ammonium groups of chitosan, thus forming a stable cross-linked structure that gels. The reaction is made to take place in such a way as to ensure that a part of the phosphate groups of phytic acid does not bind to chitosan, thus remaining free to chelate iron, for which it has a strong affinity.

The polymer is then dried and crushed to obtain a fine powder.

In the case of preparation of the polymer based on chitosan, phytic acid or salts thereof and polyaspartate, the polyaspartate solution is added to the solution of phytic acid or salts thereof with a weight ratio between polyaspartate and phytic acid (or salts thereof) equal to 0.1-10:1. The addition is preferably made in the presence of a pore-forming agent, for example KCl or NaCl.

A chitosan solution is preferably added, drop by drop, to the solution thus obtained. The weight ratio between chitosan and phytic acid or salts thereof is between 0.1 and 20, preferably between 0.1 and 10. The solution is kept under stirring until a gel forms, preferably for a time of between 30 minutes and 72 hours, more preferably between 1 and 24 hours. At the end of the reaction the gel that forms is recovered and washed if necessary. Subsequently, the gel is preferably dried and crushed to obtain a powder.

The polymer based on chitosan and phytic acid or salts thereof and the polymer based on chitosan, phytic acid or salts thereof and polyaspartate are used on their own or in combination, preferably in powder form, to remove the iron and/or calcium ion in fermented beverages, preferably alcoholic fermented beverages, more preferably red, white or rosé wine.

The polymer based on chitosan and phytic acid or salts thereof and the polymer based on chitosan, phytic acid or salts thereof and polyaspartate are used on their own or in combination to prevent the oxidation of fermented beverages caused by iron ions and act through the chelation of these ions and consequent removal thereof by entrapment in the structure of the polymer. Following treatment with the polymers of the invention, on their own or in combination, the fermented beverages keep for longer times, as the nearly total elimination of iron ions prevents oxidative phenomena that result in the deterioration of the organoleptic properties of the fermented beverage, in particular an alcoholic fermented beverage, preferably wine.

Simultaneously with the removal of iron ions, or alternatively, calcium ions present naturally in the fermented beverage are also removed; in particular, the excess calcium ions which can cause the formation of a calcium tartrate precipitate are removed. The efficiency of removal in the case of calcium ions is equivalent to at least half the concentration of ions present in the beverage; preferably, more than half the ions present in the beverage are removed with the polymers of the invention, in particular with the polymer based on chitosan, phytic acid or salts thereof and polyaspartate, which has shown to be particularly effective in removing the calcium ion. Another polymer that has shown to be particularly effective is the polymer obtained from the reaction of carboxymethyl chitosan and phytic acid or salts thereof. The typical concentrations of the calcium ion in fermented beverages, in particular in wine, can exceed 100 mg/l.

The polymers of the invention, in particular the polymer based on chitosan, phytic acid or salts thereof and polyaspartate, are thus used to prevent the formation of unaesthetic precipitates of calcium tartrate crystals. This brings about an improvement in the aesthetic and organoleptic properties of the fermented beverage, in particular of the alcoholic fermented beverage, for example red, white or rosé wine.

The method for removing iron and/or calcium ions comprises a step in which the polymers, on their own or in combination, preferably in dry powder form, are dispersed in the fermented beverage, preferably in the alcoholic fermented beverage, for example white, red or rosé wine.

In one embodiment, each polymer is used in an amount of between 0.1 and 5 g/l, preferably between 0.1 and 3 g/l, more preferably between 0.1 and 1.0 g/l.

Each polymer is suspended directly in the fermented beverage or is first suspended in a volume of water or the beverage to be treated equal to or greater than 10 times the weight of the polymer.

The beverage containing the polymer is optionally subjected to homogenisation, for example by stirring of the treated mass or recirculation by means of a pump (pumping over in closed tank).

The polymers are left in a suspension for a time of between 1 and 120 days, preferably between 3 and 60 days, more preferably between 5 and 10 days. In order to accelerate the process of absorption of the iron and/or calcium ion it is preferable to keep the suspension under stirring for the timeframes indicated.

Once the treatment has ended, the polymers are left to settle on the bottom of the tank and removed from the system by separation from the beverage, for example by decanting. Alternatively, centrifugation or filtration can be performed to separate the polymers loaded with iron and/or calcium from the beverage.

### EXAMPLES

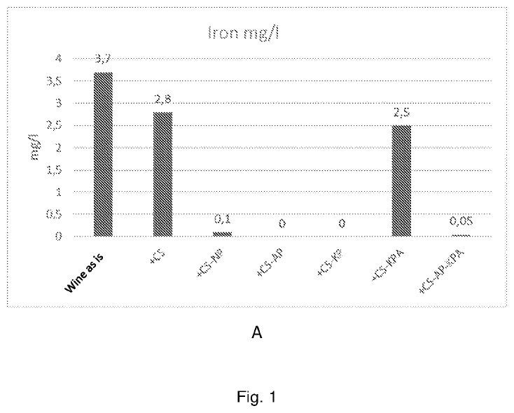

### Example No. 1—Effectiveness of Chitosan-Phytate Polymer in Removing Iron From Wine (FIG. 1)

A white wine with 3.7 mg/l of total iron is treated with 600 mg/l of chitosan of microbial origin, which is compared with a series of polymers used at the same doses:
CS-NP: chitosan-phytate polymer obtained by cross-linking the above-mentioned chitosan of microbial origin in a sodium phytate solution
CS-AP: chitosan-phytate polymer obtained by cross-linking the above-mentioned chitosan of microbial origin in a phytic acid solution
CS-KP: chitosan-phytate polymer obtained by cross-linking the above-mentioned chitosan of microbial origin in a potassium phytate solution
CS-KPA: chitosan-polyaspartate polymer obtained by cross-linking the above-mentioned chitosan of microbial origin in a potassium polyaspartate solution
CS-AP-KPA: chitosan-phytate-polyaspartate polymer obtained by cross-linking the above-mentioned chitosan of microbial origin in a phytic acid and potassium polyaspartate solution.

After 5 days of contact with frequent stirring, the polymers were separated from the wine by filtration. The results show that all the chitosan-phytate polymers, irrespective of the salt used or the presence of polyaspartate, are capable of totally eliminating the iron from wine (the mean error of the OIV analysis used to determine iron is +/−0.2 mg/l), whereas neither chitosan on its own nor the chitosan-polyaspartate polymer have comparable effectiveness.

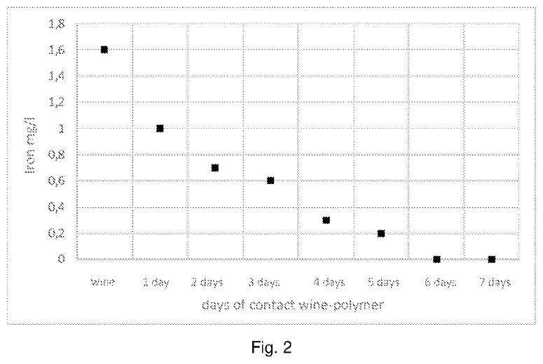

### Example No. 2—Effect of Contact Time (FIG. 2)

A white wine with an original iron content of 1.6 mg/l was subjected to a treatment of varying duration with 10 g/hl of chitosan-phytate polymer. Over 50% of the iron was absorbed by the polymer in the first 48 hours of contact; however, total removal of the metal was achieved by the 5th-6th day of treatment.

### Example No. 3—Effect of Treatment With Chitosan-Phytate Polymer on the Quality of White Wine

A white wine with a high iron content was treated with 600 mg/l of chitosan in comparison with the chitosan-phytate polymer. After two days of treatment, the wine was kept in the presence of air to accelerate the oxidation phenomena, and then subjected to chemical analyses.

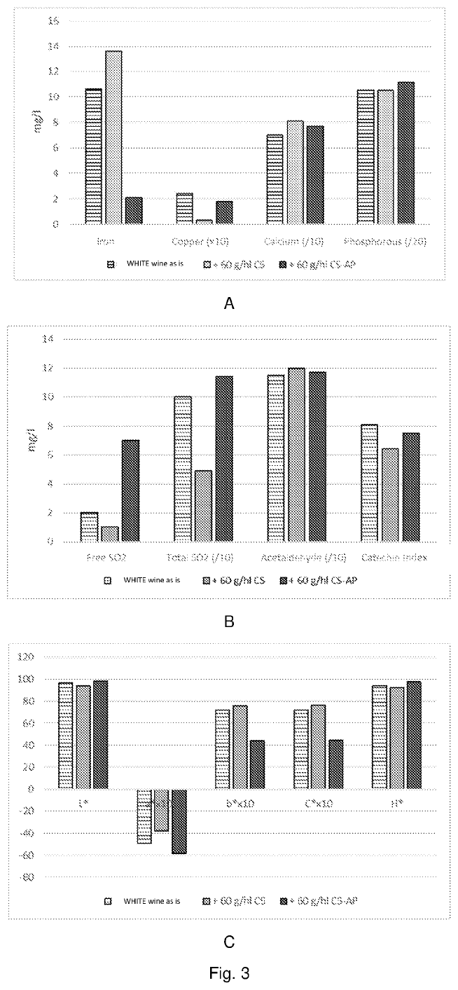

The CS-AP polymer confirms a much higher iron absorption capacity than the chitosan of which it is composed, whereas it shows no effect of reducing copper, calcium or phosphorous, thus demonstrating the selectivity of its action (FIG. 3A).

The higher content of free and total sulphur dioxide in the wine treated with CS-AP, and the stability of acetaldehyde (a product of alcohol oxidation), demonstrate a clear reduction of oxidation phenomena, which is due to removal of iron and not to any modification of the content of catechins (main polyphenols of white wine) (FIG. 3B).

The CIELab coordinates describe the colour tone of the treated wine as less red and greener than the wine as is and wine treated with chitosan alone (FIG. 3C).

### Example No. 4—Effect of Treatment With Chitosan-Phytate Polymer on the Quality of Red Wine

A red wine with a high iron content was treated with 600 mg/l of chitosan in comparison with the chitosan-phytate polymer. After two days of treatment, the wine was kept in the presence of air to accelerate the oxidation phenomena, and then subjected to chemical analyses.

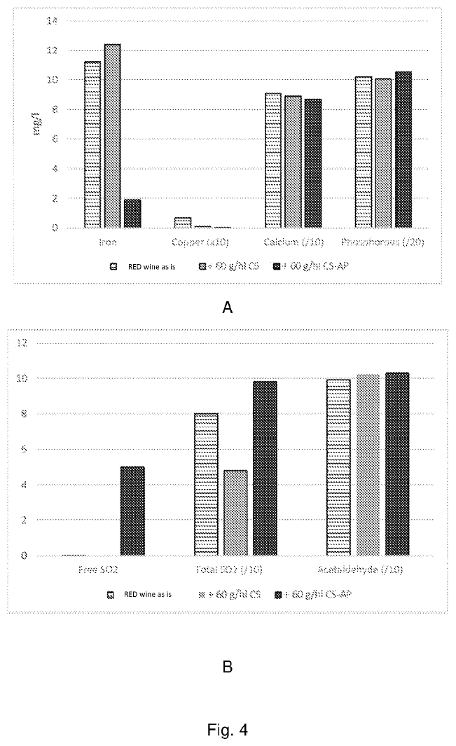

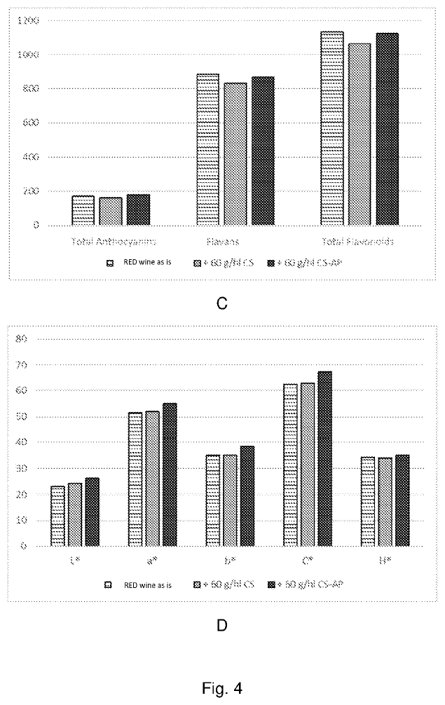

The treatment with CS-AP polymer removes the iron almost completely in only two days, without significantly altering the mineral composition of the wine (FIG. 4A).

The scant presence of the catalyst iron slows down oxidation phenomena, maintaining in the wine larger amounts of sulphur dioxide, in particular the free, active fraction thereof (FIG. 4B).

The CS-AP polymer does not significantly modify the phenolic profile of the red wine; it absorbs neither anthocyanins nor tannins (FIG. 4C).

Although the phenolic composition is unchanged compared to untreated wine, the colour indices describe the wine that remained in contact with the CS-AP polymer as redder, more luminous and with greater chromaticity (FIG. 4D).

### Example No. 5—Effectiveness of Chitosan-Phytate-Polyaspartate Polymer in Removing Iron and Calcium From Wine

A white wine with a high calcium content, susceptible to calcium tartrate instability, is subjected to treatment with 60 g/hl of the following adjuvants for comparison: a) chitosan of microbial origin, previously dissolved in 10 times its weight of an aqueous solution acidified with lactic, citric and ascorbic acid; b) chitosan-phytate polymer, suspended in 10 times its weight of water prior to its addition; c) chitosan-phytate-polyaspartate polymer added in the same manner. The polymers were synthesised using the same chitosan as in test sample a).

After 7 days of contact, with frequent resuspension of the adjuvant, the wines were decanted to remove the deposit, then subjected to chemical analysis with the official OIV method after filtration over a membrane with a porosity 0.45 micrometres. As shown in table 1, both polymers totally eliminated the iron from the wine, performing better than chitosan as is. However, only the chitosan-phytate-polyaspartate polymer demonstrated to have the ability to bind and thus remove from the system more than half of the calcium originally present in the wine in very high concentrations.

TABLE 1

| | IRON | | CALCIUM | |
|---|---|---|---|---|
| | Concentration | Reduction | Concentration | Reduction |
| | mg/l | % | mg/l | % |
| Wine prior to | 4.6 | | 205 | |
| treatment | | | | |
| Wine treated | 2.3 | 50% | 150 | 27% |
| with 0.60 g/l | | | | |
| of chitosan | | | | |
| Wine treated | n.d. | 100% | 180 | 17% |
| with 0.60 g/l | | | | |
| of chitosan- | | | | |
| phytate | | | | |
| polymer | | | | |
| Wine treated | n.d | 100% | 75 | 63% |
| with 0.60 g/l | | | | |
| of chitosan- | | | | |
| phytate- | | | | |
| polyaspartate | | | | |
| polymer | | | | |

1. Use of a polymer obtained from the cross-linking reaction between chitosan and/or a derivative thereof, preferably carboxymethyl chitosan, and phytic acid or a salt thereof, to prevent and/or to mitigate oxidation of a fermented beverage, preferably an alcoholic fermented beverage, more preferably wine.

2. Use of the polymer according to claim 1, wherein the oxidation is caused by the presence of iron ion.

3. Use of a polymer obtained by the cross-linking reaction between chitosan and/or a derivative thereof, preferably carboxymethyl chitosan, and phytic acid or a salt thereof, to remove the iron ion from a fermented beverage, preferably from an alcoholic fermented beverage, more preferably from wine.

4. Use of a polymer obtained by the cross-linking reaction between chitosan and/or a derivative thereof, preferably carboxymethyl chitosan, and phytic acid or a salt thereof, to extend the shelf life of a fermented beverage, preferably an alcoholic fermented beverage, more preferably wine.

5. Use according to claim 1, wherein the polymer is obtained by the cross-linking reaction between the chitosan of formula (I): 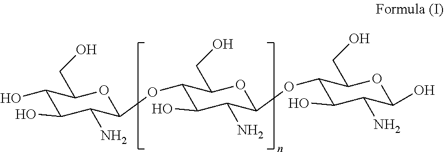
and/or a derivative thereof, preferably carboxymethyl chitosan,
and phytic acid of formula (II): 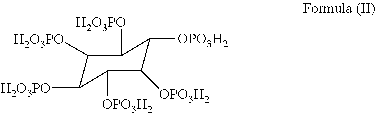
or a salt thereof, preferably a salt of an alkali or alkaline-earth metal, more preferably a phytate of sodium, potassium, calcium, magnesium or combinations thereof.

6. Use according to claim 1, wherein the weight ratio of phytic acid to chitosan is between 0.1 and 20, preferably between 0.1 and 10.

7. Use according to claim 1, wherein the wine is selected from: white wine, red wine or rosé wine.

8. (canceled)

9. Use according to claim 1, wherein the polymer is in powder form.

10. (canceled)

11. (canceled)
